(19) United States
(12) Patent Application Publication
(10) Pub. No.: US 2015/0035771 A1
(43) Pub. Date: Feb. 5, 2015

(54) METHOD AND APPARATUS FOR PERCEIVING OPEN/CLOSED STATUS OF COVER OF TERMINAL

(71) Applicant: Samsung Electronics Co., Ltd., Gyeonggi-do (KR)

(72) Inventors: Sung-Jin Park, Seoul (KR); Seul-a Kim, Seoul (KR); Seung-heon Lee, Gyeonggi-do (KR)

(73) Assignee: Samsung Electronics Co., Ltd.

(21) Appl. No.: 14/341,176

(22) Filed: Jul. 25, 2014

(30) Foreign Application Priority Data
Aug. 5, 2013 (KR) 10-2013-0092666

(51) Int. Cl. G06F 3/041; H04B 1/38

(52) U.S. Cl. CPC G06F 3/0412; H04B 1/3888
USPC 345/173

(57) ABSTRACT

A method of perceiving an open/closed state of a terminal cover includes sensing a signal of a touched region of a screen of a terminal, determining whether the touched region corresponds to a predetermined region of the screen of the terminal, based on the sensed signal, and determining whether the terminal cover is combined with the screen of the terminal, based on a result of the determining whether the touched region corresponds to the predetermined region.

### PRIORITY

This application claims priority to Korean Patent Application No. 10-2013-0092666, filed in the Korean Intellectual Property Office on Aug. 5, 2013, the contents of which are incorporated herein by reference.

### BACKGROUND OF THE INVENTION

1. Field of the Invention

The present invention relates generally to a terminal, and more particularly, to a method and apparatus for perceiving an open/closed state of a cover of a terminal.

2. Description of the Related Art

A protective film or a terminal cover has conventionally been used to protect a surface of a terminal having a display unit against shock. In particular, the terminal cover is made of a material such as plastic or leather, which is appropriate to protect the surface of the terminal. The terminal cover is formed to a predetermined thickness or more to effectively protect the terminal against external shock or pressure.

However, when the terminal includes the terminal cover, the display unit of the terminal may be hidden by the terminal cover. For example, the terminal cover has to be opened and a button on the terminal has to be pressed to check a message received by the terminal or a current status of the terminal. Accordingly, there is a need in the art for a method of enabling the terminal to perceive an open/closed state of the terminal cover.

### SUMMARY OF THE INVENTION

The present invention has been made to address at least the above-mentioned problems and/or disadvantages and to provide at least the advantages described below. Accordingly, an aspect of the present invention is to provide a method and apparatus for perceiving an open/closed state of a terminal cover.

Another aspect of the present invention is to provide a computer readable recording medium having recorded thereon a program for enabling a computer to execute the method and apparatus for perceiving an open/closed state of the terminal cover.

In accordance with an aspect of the present invention, there is provided a method of perceiving an open/closed state of a cover of a terminal, including sensing a signal of a touched region of a screen of the terminal, determining whether the touched region corresponds to a predetermined region of the screen of the terminal, based on the sensed signal, and determining whether a terminal cover is combined with the screen of the terminal, based on a result of the determining whether the touched region corresponds to the predetermined region.

In accordance with another aspect of the present invention, there is provided a non-transitory computer readable recording medium having recorded thereon a program for enabling a computer to execute the method of perceiving an open/closed state of a cover of a terminal, the method including sensing a signal of a touched region of a screen of the terminal, determining whether the touched region corresponds to a predetermined region of the screen of the terminal, based on the sensed signal, and determining whether a terminal cover is combined with the screen of the terminal, based on a result of the determining whether the touched region corresponds to the predetermined region.

In accordance with another aspect of the present invention, there is provided an apparatus for perceiving an open/closed state of a cover of a terminal, the apparatus including a sensing unit configured to sense a signal of a touched region of a screen of the terminal, a first determination unit configured to determine whether the touched region corresponds to a predetermined region of the screen of the terminal, based on the signal which touches the region of the screen of the terminal, and a second determination unit configured to determine whether the terminal cover is combined with the screen of the terminal, based on a result of the determining whether the touched region corresponds to the predetermined region.

### BRIEF DESCRIPTION OF THE DRAWINGS

The above and other aspects, features and advantages of the present invention will become apparent and more readily appreciated from the following description of the embodiments, taken in conjunction with the accompanying drawings in which:

FIG. 1 is a block diagram of an open/closed state perceiving apparatus according to an embodiment of the present invention;

FIG. 2 illustrates a terminal cover on which objects are arranged according to an embodiment of the present invention;

FIGS. 3A and 3B illustrate an operation of a first determination unit according to an embodiment of the present invention;

FIG. 4 is a block diagram of an open/closed state perceiving apparatus according to another embodiment of the present invention;

FIG. 5 is a flowchart of an operation of an open/closed state perceiving apparatus according to an embodiment of the present invention;

FIG. 6 is a block diagram of an open/closed state perceiving apparatus according to another embodiment of the present invention;

FIGS. 7A, 7B and 7C illustrate examples of images output to a surface of a terminal cover according to an embodiment of the present invention; and

FIG. 8 is a flowchart of a method of perceiving an open/closed state of a terminal cover according to an embodiment of the present invention.

### DETAILED DESCRIPTION OF EMBODIMENTS OF THE PRESENT INVENTION

Embodiments of the present invention will be described in detail with reference to the accompanying drawings. It should be noted that the same elements will be designated by the same reference numerals although they are shown in different drawings. Detailed description of well-known functions or configurations will be omitted for the sake of clarity and conciseness.

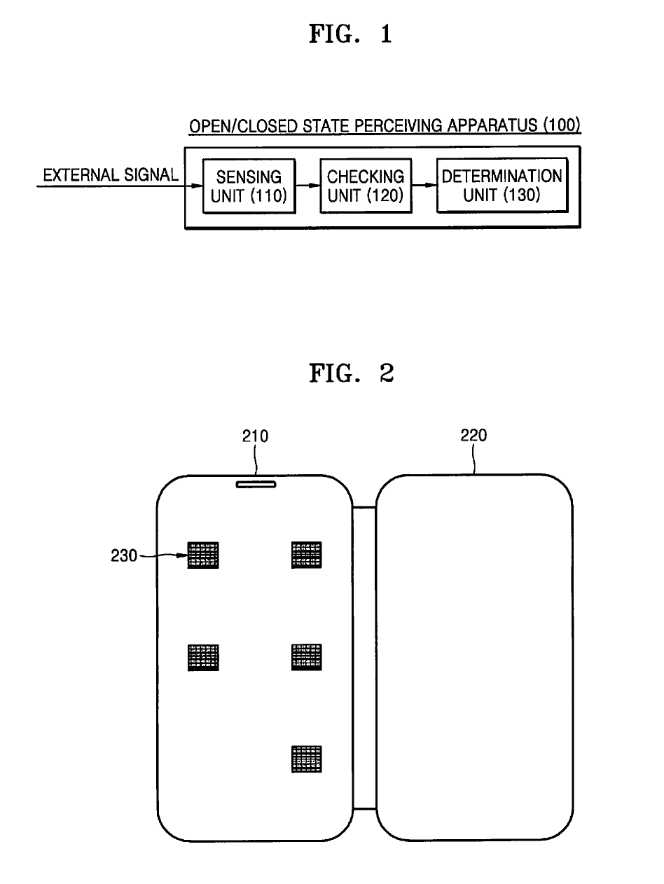

FIG. 1 is a block diagram of an open/closed state perceiving apparatus 100 according to an embodiment of the present invention.

Referring to FIG. 1, the open/closed state perceiving apparatus 100 includes a sensing unit 110, a first determination unit 120, and a second determination unit 130. FIG. 1 illustrates only some elements of the open/closed state perceiving apparatus 100 that are related to the present embodiment. Thus, it will be apparent to those of ordinary skill in the art FIG. 1 that the open/closed state perceiving apparatus 100 may further include other conventional elements.

Also, it will be apparent to those of ordinary skill in the art that the sensing unit 110, the first determination unit 120, and the second determination unit 130 of the open/closed state perceiving apparatus 100 of FIG. 1 may be installed as independent devices.

The sensing unit 110, the first determination unit 120, and the second determination unit 130 of the open/closed state perceiving apparatus 100 of FIG. 1 may correspond to one or more processors that are each embodied as an array of a plurality of logic gates or a combination of a general-purpose microprocessor and a memory storing a program that can be run by the microprocessor. Also, it will be apparent to those of ordinary skill in the art that each of the one or more processors may be embodied as another type of hardware.

The sensing unit 110 senses a signal of a touched region of a screen of a terminal. The signal of the touched region of the screen of the terminal indicates an external signal generated when at least one object arranged on the terminal cover contacts the screen of the terminal.

For example, the terminal may be a mobile phone such as a smartphone, but is not limited thereto. In other words, the terminal type is not limited, provided it includes a display screen and is a portable device.

The at least one object is a conductive material having a capacitance and is arranged on an inner surface of the terminal cover, as will be described in detail with reference to FIG. 2.

Specifically, FIG. 2 illustrates a terminal cover on which objects are arranged according to an embodiment of the present invention.

Referring to FIG. 2, one surface 210 of the terminal cover is to be combined with a screen of a terminal, and another surface 220 of the terminal cover is to be combined with a rear surface of the terminal. At least one object 230 is arranged on the surface 210 of the terminal cover.

Although FIG. 2 illustrates that the at least one object 230 is arranged on five locations on the terminal cover, respectively, embodiments of the present invention are not limited thereto. In other words, the number of the at least one object 230 may vary according to the number of different locations that the terminal is capable of simultaneously perceiving using signals input to the screen of the terminal. For example, if it is assumed that the terminal is capable of performing 5-point multi-touch sensing to simultaneously perceive five locations, the number of the at least one object 230 arranged on the terminal cover is five. If it is assumed that the terminal is capable of simultaneously perceiving two different locations, the number of the at least one object 230 arranged on the terminal cover is two.

The at least one object 230 indicates a conductive material having a capacitance. The at least one object 230 is arranged on a location such that it is in contact with the screen of the terminal. Specifically, when the at least one object 230 contacts a region of the screen of the terminal including an electrostatic touch sensor, the sensing unit 110 may sense a touch signal.

Referring back to FIG. 1, the first determination unit 120 determines whether the touched region corresponds to a predetermined region of the screen of the terminal, based on the sensed signal. In detail, the first determination unit 120 determines whether each of the at least one object 230 contacts the predetermined region of the screen of the terminal, based on the signal sensed by the sensing unit 110.

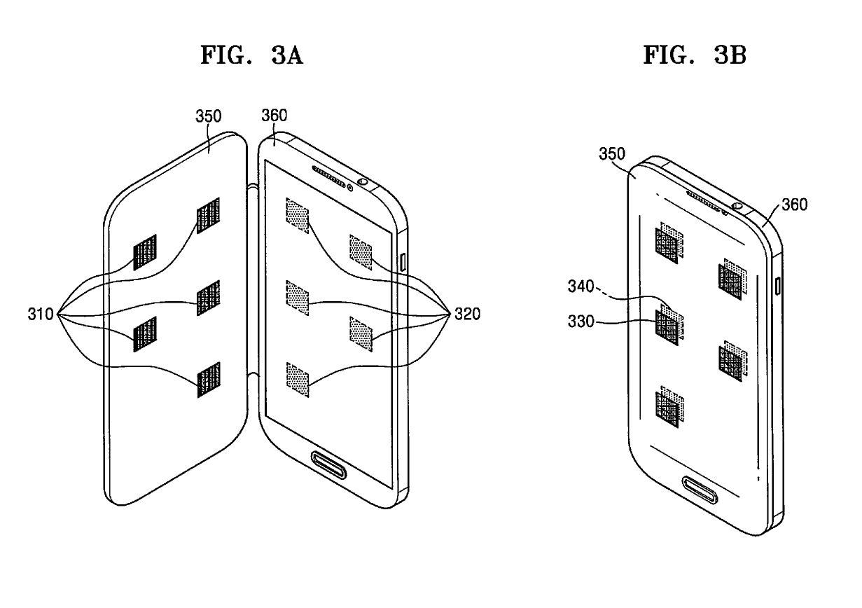

FIGS. 3A and 3B illustrate an operation of a first determination unit, according to an embodiment of the present invention.

FIG. 3A illustrates an example of a terminal cover 350 combined with a terminal 360. Objects 310 are arranged on different locations on an inner surface of the terminal cover 350.

The first determination unit 120 of FIG. 1 determines whether the objects 310 arranged on the terminal cover 350 contact predetermined regions 320 on a screen of the terminal 360. The predetermined regions 320 are symmetrical to the objects 310 about a mid-point between the terminal cover 350 and the terminal 360, as will be described in detail with reference to FIG. 3B.

Specifically, FIG. 3B illustrates a state in which the terminal cover 350 is combined with the terminal 360. In this state, the objects 330 arranged on the inner surface of the terminal cover 350 contact the screen of the terminal 360.

In this case, the first determination unit 120 determines whether regions of the screen of the terminal 360 are in contact with the objects 330. In other words, the first determination unit 120 detects the regions of the screen of the terminal 360 that are in contact with the objects 330, based on a sensed signal received by the sensing unit 110. Then, the first determination unit 120 determines whether the regions that are in contact with the objects 330 correspond to predetermined regions 340.

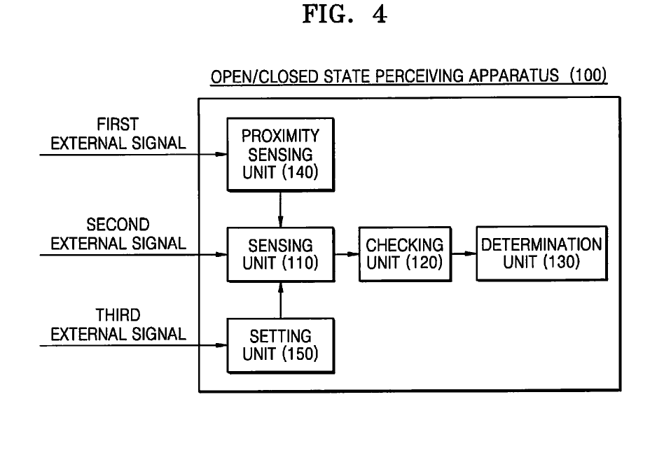

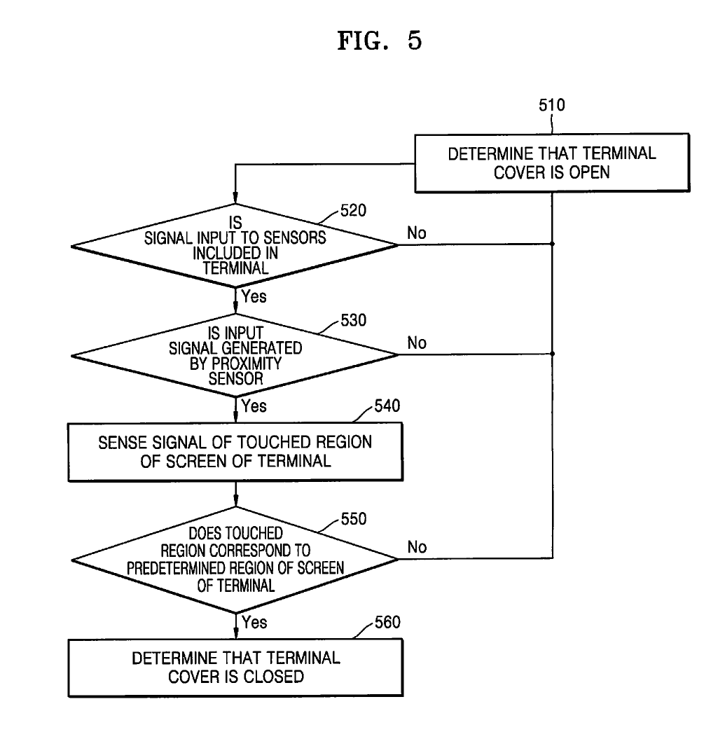

The predetermined regions 340 are set as regions of the screen of the terminal 360 that the objects 330 contact, respectively, when the terminal cover 350 is combined with the terminal 360. A method of setting the predetermined regions 340 will be described in detail with reference to FIG. 4.

Referring back to FIG. 3A, it is determined whether the terminal cover 350 is combined with the screen of the terminal 360 based on whether the objects 310 contact the predetermined regions 320 of the screen of the terminal 360.

Referring back to FIG. 1, the second determination unit 130 determines whether the terminal cover 350 is combined with the screen of the terminal 360, based on a result of the determination performed by the first determination unit 120. In detail, the second determination unit 130 determines that the terminal cover 350 is combined with the screen of the terminal 360 when the objects 310 arranged on the terminal cover 350 respectively contact the predetermined regions 320 on the screen of the terminal 360, and determines that the terminal cover 350 is not combined with the screen of the terminal 360 when the objects 310 arranged on the terminal cover 350 do not contact the predetermined regions 320 on the screen of the terminal 360, based on the result of the determination performed by the 1^{st} determination unit 120

As described above, the open/closed state perceiving apparatus 100 is capable of exactly determining whether a terminal cover is combined with a screen of a terminal that includes an electrostatic touch sensor, based on whether objects on the terminal cover contact a screen of the terminal.

FIG. 4 is a block diagram of an open/closed state perceiving apparatus 100 according to another embodiment of the present invention.

Referring to FIG. 4, the open/closed state perceiving apparatus 100 includes a sensing unit 110, a first determination unit 120, and a second determination unit 130, and further includes a proximity-sensing unit 140 and a setting unit 150. Although FIG. 4 illustrates only some elements of the open/closed state perceiving apparatus 100 that are related to the present embodiment, it will be apparent to those of ordinary skill in the art that the open/closed state perceiving apparatus 100 may further include other conventional elements.

Also, it will be apparent to those of ordinary skill in the art that the elements of the open/closed state perceiving apparatus 100 illustrated in FIG. 4 may be installed as independent devices.

The elements of the open/closed state perceiving apparatus 100 illustrated in FIG. 4 may correspond to one or more processors that are embodied as an array of a plurality of logic gates or a combination of a general-purpose microprocessor and a memory storing a program that can be run by the microprocessor. Also, it will be apparent to those of ordinary skill in the art that each of the one or more processors may be embodied as another type of hardware.

Operations of the sensing unit 110, the first determination unit 120, and the second determination unit 130 of FIG. 4 are as described above with reference to FIG. 1 and are not will not be described again here. In FIG. 4, a second external signal is the same as the external signal of FIG. 1.

The proximity-sensing unit 140 determines whether a terminal cover is located adjacent to a screen of a terminal, based on a signal input to a proximity sensor included in the terminal. In detail, the proximity-sensing unit 140 determines whether the terminal cover is located adjacent to the terminal screen, based on a first external signal received via the proximity sensor.

A terminal includes a proximity sensor that indicates a sensor capable of sensing whether an external object including a user has been brought adjacent to the terminal. Thus, the proximity sensor may be used to determine whether the terminal cover has been brought adjacent to the terminal, i.e., whether the terminal cover is combined with the screen of the terminal.

According to an embodiment of the present invention, the open/closed state perceiving apparatus 100 is capable of exactly determining whether a terminal cover is combined with a screen of a terminal, based on whether objects arranged on the terminal cover contact the screen of the terminal and whether the proximity sensor senses whether the terminal cover has been brought adjacent to the terminal.

FIG. 5 is a flowchart of an operation of an open/closed state perceiving apparatus, according to an embodiment of the present invention.

In step 510, it is assumed that a terminal cover is not combined with a screen of a terminal (i.e., the terminal cover is open).

In step 520, the proximity-sensing unit 140 determines whether a signal is input to sensors included in the terminal. Step 530 is performed when a signal is input to the sensors, and step 510 is performed when a signal is not input to the sensors.

In step 530, the proximity-sensing unit 140 determines whether the input signal is generated by a proximity sensor. In other words, the proximity-sensing unit 140 determines whether an external object has been brought adjacent to the screen of the terminal. An example of the external object includes the terminal cover. Step 540 is performed when the input signal is generated by the proximity sensor, and step 510 is performed when the input signal is not generated by the proximity sensor.

In step 540, the sensing unit 110 senses a signal based on a result of the determining performed by the proximity-sensing unit 140. In other words, after the proximity-sensing unit 140 determines that the external object has been brought adjacent to the screen of the terminal, the sensing unit 110 senses a signal of a touched region of the screen of the terminal. An operation of the sensing unit 110 is as described above with reference to FIG. 1.

In step 550, the first determination unit 120 determines whether the touched region of the screen of the terminal corresponds to a predetermined region of the screen of the terminal, based on the signal sensed by the sensing unit 110. In other words, the first determination unit 120 determines whether a region of the screen of the terminal that at least one object arranged on the terminal cover contacts corresponds to the predetermined region of the screen of the terminal. An operation of the first determination unit 120 is as described above with reference to FIG. 1. Step 560 is performed when the region of the screen of the terminal that the at least one object contacts corresponds to the predetermined region of the screen of the terminal, and step 510 is performed when the region of the screen of the terminal that the at least one object contacts does not correspond to the predetermined region of the screen of the terminal.

In step 560, the second determination unit 130 determines that the terminal cover is combined with the screen of the terminal (i.e., the terminal cover is closed), based on the determination performed by the first determination unit 120 in step 550.

As described above, the open/closed state perceiving apparatus 100 is capable of exactly determining whether a terminal cover is open or closed by using not only objects arranged on a terminal cover but also a proximity sensor included in a terminal.

Referring back to FIG. 4, the setting unit 150 sets a predetermined region, based on a signal obtained when the terminal cover is combined with the screen of the terminal. Specifically, the setting unit 150 sets the predetermined regions 320 described above with reference to FIG. 3 by using a third external signal indicating that the terminal cover is combined with the screen of the terminal.

Various types of terminal covers may be combined with one terminal. In other words, the number of objects attached to and regions on a terminal cover may vary depending on the terminal cover type. Thus, a process of exactly setting sensing regions on a screen of a terminal to correspond to the number of objects attached to and the region of the terminal cover combined with a current terminal needs to be performed.

The setting unit 150 calibrates the sensing regions of the screen of the terminal, based on the signal obtained when the terminal cover is combined with the screen of the terminal. Specifically, the setting unit 150 detects regions of the screen of the terminal with which objects are in close contact when the terminal cover is combined with the screen of the terminal. Then, the setting unit 150 sets the detected regions as sensing regions (i.e., the predetermined regions 320 of FIG. 3).

The setting unit 150 may be operated at a point of time when the terminal cover is first combined with the terminal so as to set predetermined regions or to update previously set predetermined regions, according to user input.

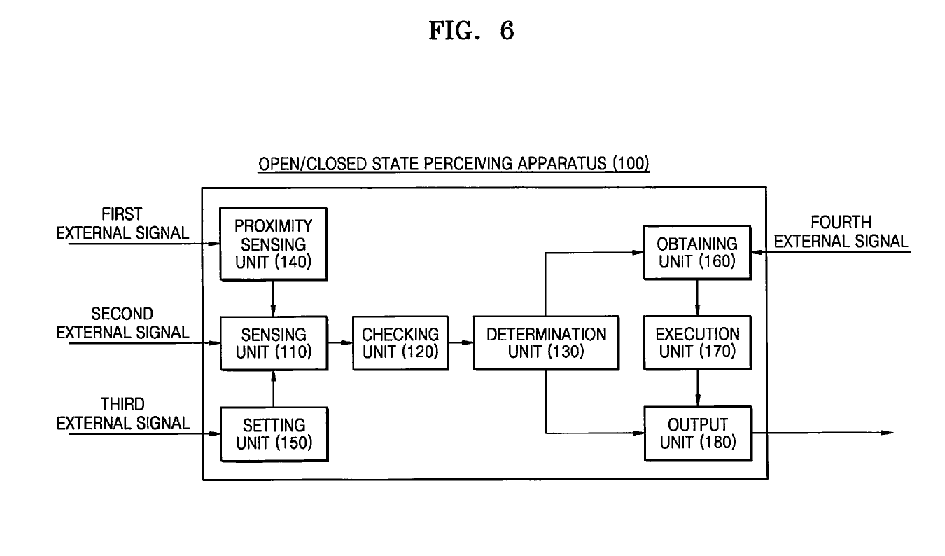

FIG. 6 is a block diagram of an open/closed state perceiving apparatus 100 according to another embodiment of the present invention.

Referring to FIG. 6, the open/closed state perceiving apparatus 100 includes a sensing unit 110, a first determination unit 120, a second determination unit 130, a proximity-sensing unit 140, and a setting unit 150, and further includes an obtaining unit 160, an execution unit 170, and an output unit 180. Although FIG. 6 illustrates only some elements of the open/closed state perceiving apparatus 100 that are related to the present embodiment, it will be apparent to those of ordinary skill in the art that the open/closed state perceiving apparatus 100 may further include other conventional elements.

It will also be apparent to those of ordinary skill in the art that the elements of the open/closed state perceiving apparatus 100 illustrated in FIG. 6 may be installed as independent devices.

The elements of the open/closed state perceiving apparatus 100 illustrated in FIG. 6 may correspond to one or more processors embodied as an array of a plurality of logic gates or a combination of a general-purpose microprocessor and a memory storing a program that can be run by the microprocessor. It will also be apparent to those of ordinary skill in the art that each of the one or more processors may be embodied as another type of hardware.

Operations of the sensing unit 110, the first determination unit 120, the second determination unit 130, the proximity-sensing unit 140, and the setting unit 150 are as described above with reference to FIG. 1 or 4 and thus will not be described again here.

The output unit 180 outputs a predetermined image to a surface of a terminal cover, based on a result of determination performed by the second determination unit 130. Specifically, when the output unit 180 receives information indicating that the terminal cover is combined with a screen of a terminal from the second determination unit 130, the output unit 180 outputs the predetermined image to the surface of the terminal cover. Examples of the predetermined image include an image for executing an application installed in the terminal.

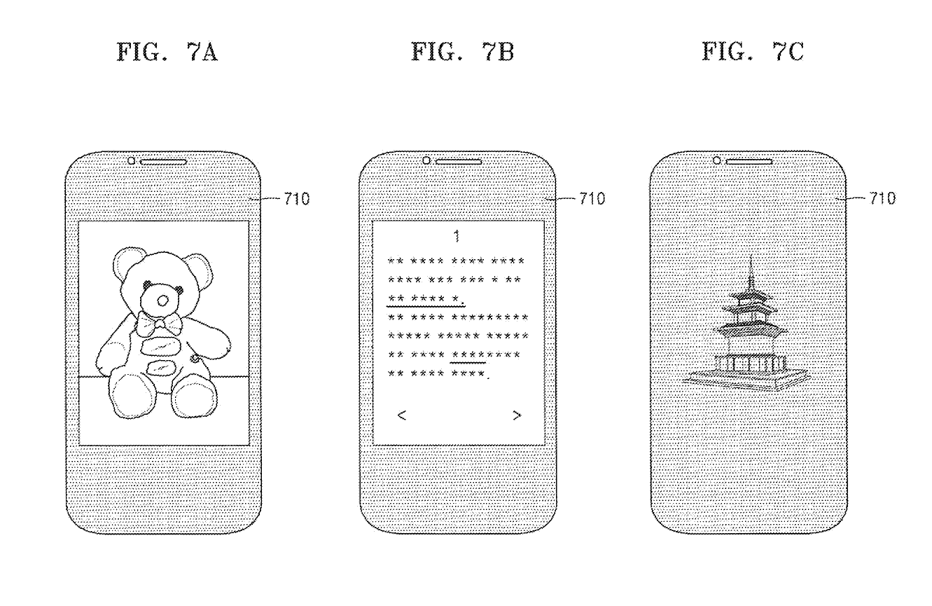

FIGS. 7A, 7B, and 7C illustrate examples of a predetermined image output to a surface of the terminal cover. According to an embodiment of the present invention, a thin reflective display 710 may be installed on the surface of the terminal cover so that a user may always check a status of a terminal. For example, an Electrophoretic Panel Display (EPD) may be installed on the surface of the terminal cover, although embodiments of the present invention are not limited thereto.

In this case, it is required to distinguish between when the terminal cover is closed and when the terminal cover is open. For example, when the terminal cover is open, an image need not be output to the surface of the terminal cover. This is because when a user pulls the terminal cover to open the terminal cover, the terminal cover, on which a display is installed, is located at a rear surface of the screen of the terminal and the display is thus hidden by the screen of the terminal. In this case, an image need not be output to the surface of the terminal cover. In other words, an image is output to the surface of the terminal cover only when the user closes the terminal cover to combine the terminal cover with the screen of the terminal.

Thus, the output unit 180 outputs the predetermined image to the surface of the terminal cover when the output unit 180 receives information indicating that the terminal cover is combined with the screen of the terminal from the second determination unit 130.

Various types of images may be output to the surface of the terminal cover when the terminal cover is combined with the screen of the terminal. For example, an image output to the surface of the terminal cover may include pictures as illustrated in FIG. 7A, may include characters as illustrated in FIG. 7B, or may have the same background color as the terminal cover as illustrated in FIG. 7C.

In this case, the image output to the surface of the terminal cover may be for executing an application installed in the terminal. For example, when an application informing about current weather conditions is installed in the terminal, an image showing current weather conditions of an area in which a user is located may be output to the surface of the terminal cover but embodiments of the present invention are not limited thereto.

Referring back to FIG. 6, the obtaining unit 160 receives a signal input to the surface of the terminal cover, based on a result of determination performed by the second determination unit 130. The execution unit 170 executes an application installed in the terminal by using the signal received by the obtaining unit 160.

Specifically, when the obtaining unit 160 receives information indicating that the terminal cover is combined with the screen of the terminal from the second determination unit 130, the obtaining unit 160 receives a fourth external signal, which is a user signal input to the surface of the terminal cover. The execution unit 170 executes the application installed in the terminal or inputs a predetermined command to the executed application, based on the fourth external signal received by the obtaining unit 160.

According to an embodiment of the present invention, a user may perform a predetermined interaction with a terminal even when a terminal cover is combined with the screen of the terminal. In other words, the user may control an operation of an application installed in the terminal even when the terminal cover is combined with the screen of the terminal. In this case, some objects arranged on the terminal cover may be used to determine whether the terminal cover is combined with the screen of the terminal, and the other objects may be used to receive the fourth external signal.

The obtaining unit 160 receives the fourth external signal input to the surface of the terminal cover. The fourth external signal may be a gesture signal containing information indicating an operation to be performed by the terminal. For example, the fourth external signal may be a drag-and-drop signal for replacing a current image output to the surface of the terminal cover with another image or a touch signal for selecting a desired portion of an image output to the surface of the terminal cover.

The execution unit 170 executes an application installed in the terminal, based on the information contained in the fourth external signal received by the obtaining unit 160. For example, the execution unit 170 may update an image for executing an application that is being executed or execute another application. The output unit 180 outputs an image for executing an application, which corresponds to the fourth external signal, to the surface of the terminal cover, based on information received from the execution unit 170.

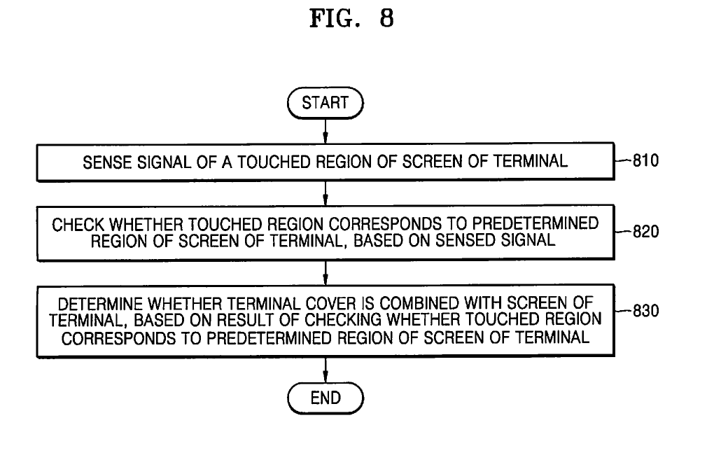

FIG. 8 is a flowchart of a method of perceiving an open/closed state of a terminal cover according to an embodiment of the present invention.

Referring to FIG. 8, the method of perceiving an open/closed state of a terminal cover includes operations to be sequentially performed by the open/closed state perceiving apparatus 100 of FIG. 1, 4, or 6. Thus, the above description of the open/closed state perceiving apparatus 100 of FIG. 1, 4, or 6 also applies to the method of FIG. 8.

In step 810, the sensing unit 110 senses a signal of a touched region of the screen of a terminal. Examples of the signal of a touched region of the screen of the terminal include a signal generated when at least one object arranged on a terminal cover contacts the screen of the terminal.

In step 820, the first determination unit 120 determines whether the touched region corresponds to a predetermined region of the screen of the terminal, based on the sensed signal.

In step 830, the second determination unit 130 determines whether the terminal cover is combined with the screen of the terminal, based on a result of the checking performed by the first determination unit 120.

As described above, according to the one or more of the above embodiments of the present invention, an open/closed state of the terminal cover combined with the terminal can be exactly perceived. Also, the open/closed state of the terminal cover may be perceived without an additional hall sensor, thereby preventing an increase in manufacturing costs when the hall sensor is installed in the terminal. The present invention is applicable to various types of terminals that do not include the hall sensor.

In addition, other embodiments of the present invention can also be implemented through computer readable code/instructions in/on a medium, e.g., a computer readable medium, to control at least one processing element to implement any above-described embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., Read-Only Memory (ROM), Random Access Memory (RAM), Universal Serial bus (USB) memory, floppy disks, hard disks, etc.) and optical recording media (e.g., CD-ROMs, Digital Video Discs (DVDs), etc.), and a Personal Computer (PC) interface (e.g., a Peripheral Component Interconnect (PCI), a PCI-express, Wifi, etc.).

It should be understood that the embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method of perceiving an open/closed state of a terminal having a cover, the method comprising:
sensing a signal of a touched region of a screen of the terminal;
determining whether the touched region corresponds to a predetermined region of the screen of the terminal, based on the sensed signal; and
determining whether the terminal cover is combined with the screen of the terminal, based on a result of the determining whether the touched region corresponds to the predetermined region.

2. The method of claim 1, wherein the signal of the touched region comprises a signal generated when at least one object arranged on the terminal cover contacts the screen of the terminal, and
determining whether the touched region corresponds to the predetermined region comprises determining whether each of the at least one object contacts the predetermined region of the screen of the terminal.

3. The method of claim 1, further comprising determining whether the terminal cover has been brought adjacent to the screen of the terminal, based on a signal input to a proximity sensor included in the terminal, and
wherein sensing the signal of the touched region of the screen of the terminal comprises sensing the signal based on the result of determining whether the touched region corresponds to the predetermined region.

4. The method of claim 1, further comprising outputting a predetermined image to a surface of the terminal cover, based on a result of determining whether the terminal cover is combined with the screen of the terminal.

5. The method of claim 4, wherein the predetermined image comprises an image for executing an application installed in the terminal.

6. The method of claim 1, further comprising:
receiving a signal input to a surface of the terminal cover, based on a result of determining whether the terminal cover is combined with the screen of the terminal; and
executing an application installed in the terminal, based on the received signal.

7. The method of claim 1, further comprising setting the predetermined region, based on a signal obtained when the terminal cover is combined with the screen of the terminal.

8. The method of claim 2, wherein the at least one object comprises a conductive material.

9. The method of claim 2, wherein the at least one object is located on five locations on the terminal cover, respectively.

10. A non-transitory computer readable recording medium having recorded thereon a program for enabling a computer to execute a method of perceiving an open/closed state of a terminal having a terminal cover, the method comprising:
sensing a signal of a touched region of a screen of the terminal;
determining whether the touched region corresponds to a predetermined region of the screen of the terminal, based on the sensed signal; and
determining whether the terminal cover is combined with the screen of the terminal, based on a result of the determining whether the touched region corresponds to the predetermined region.

11. An apparatus for perceiving an open/closed state of a terminal having a cover, the apparatus comprising:
a sensing unit configured to sense a signal of a touched region of a screen of the terminal;
a 1^{st} determination unit configured to determine whether the touched region corresponds to a predetermined region of the screen of the terminal, based on the signal which touches the region of the screen of the terminal; and
a 2^{nd} determination unit configured to determine whether the terminal cover is combined with the screen of the terminal, based on a result of the determining whether the touched region corresponds to the predetermined region.

12. The apparatus of claim 11, wherein the signal of the touched region comprises a signal generated when at least one object arranged on the terminal cover contacts the screen of the terminal, and
the 1^{st} determination unit is further configured to determine whether the at least one object contacts the predetermined region of the screen of the terminal.

13. The apparatus of claim 11, further comprising a proximity-sensing unit configured to determine whether the terminal cover has been brought adjacent to the screen of the terminal, based on a signal input to a proximity sensor included in the terminal,
wherein the sensing unit is further configured to sense the signal of the touched region, based on a result of the determining whether the terminal cover has been brought adjacent to the screen of the terminal.

14. The apparatus of claim 11, further comprising an output unit configured to output a predetermined image to a surface of the terminal cover, based on a result of determining whether the terminal cover is combined with the screen of the terminal.

15. The apparatus of claim 14, wherein the predetermined image comprises an image for executing an application installed in the terminal.

16. The apparatus of claim 11, further comprising:
an obtaining unit configured to receive a signal input to a surface of the terminal cover, based on a result of determining whether the terminal cover is combined with the screen of the terminal; and
an execution unit configured to execute the application installed in the terminal by using the received signal.

17. The apparatus of claim 11, further comprising a setting unit configured to set the predetermined region, based on a signal obtained when the terminal cover is combined with the screen of the terminal.

18. The apparatus of claim 12, wherein the at least one object comprises a conductive material.

19. The apparatus of claim 11, wherein the at least one object is located on five locations on the terminal cover, respectively.
